(19) United States
(12) Patent Application Publication
(10) Pub. No.: US 2026/0281778 A1
(43) Pub. Date: Sep. 17, 2026

(54) UE REPORTING OF NETWORK ENERGY SAVINGS RELATED PERFORMANCE DEGRADATION

(71) Applicant: Telefonaktiebolaget LM Ericsson (publ), Stockholm (SE)

(72) Inventors: Ali NADER, Malmo (SE); Andres REIAL, Hollviken (SE); Sina MALEKI, Malmo (SE); Helka-Liina MÄÄTTÄNEN, Espoo (FI); Sladana JOSILO, Solna (SE); Lian ARAUJO, Solna (SE)

(21) Appl. No.: 19/473,326

(22) PCT Filed: Apr. 5, 2024
(86) PCT No.: PCT/IB2024/053348

§ 371 Date: Oct. 7, 2025

Related U.S. Application Data
(60) Provisional application No. 63/494,826, filed on Apr. 7, 2023.

(51) Int. Cl. H04W 24/10; H04W 24/08; H04W 52/02

(52) U.S. Cl. CPC H04W 24/10; H04W 24/08; H04W 52/0206

(57) ABSTRACT

Various embodiments disclosed herein provide for a method for configuring a User Equipment (UE) to store and report information related to performance degradation associated with Network Energy Savings (NES) features that are configured or active in the cell in which the UE is connected at the time of the performance degradation. The UE can receive a configuration to store and report the information, and then the UE can determine when an NES feature is activated or configured in the cell, and then when performance degradation occurs (e.g., radio link failure or handover failure) the UE can store the information and then report the information to a network node.

### RELATED APPLICATIONS

This application claims the benefit of provisional patent application Ser. No. 63/494,826, filed Apr. 7, 2023, the disclosure of which is hereby incorporated herein by reference in its entirety.

### TECHNICAL FIELD

The present disclosure relates to a method for reporting network energy savings related performance degradation in a wireless communication system.

### BACKGROUND

### Network Energy Consumption

Energy consumption is a considerable challenge of Fifth Generation (5G) systems (5GS) today where a major contributor to the energy consumption is the radio unit of Radio Access Network (RAN) system. The Network (NW) power consumption for New Radio (NR) is said to be less compared to Long Term Evolution (LTE) because of its lean design, i.e., no Cell Specific Reference Signal (CRS) and the Synchronization Signal Block (SSB) periodicity is by default 20 ms. However, NR in the current implementation might consume more energy compared to LTE, partly due to higher bandwidths (BWs), shorter Transmit Time Intervals (TTIs) and massive number of antennas. This is still evident even at times when cells and beams are lightly loaded or serve no traffic or no users at all. To enable an energy efficient NW, Third Generation Partnership Project (3GPP) initiated a study item (SI) on Network Energy Savings (NES) in NR, which was concluded with the outcome captured in TR 38.864.

Following the SI phase, a new work item (WI) on NES for NR was approved at RAN #98. The WI aims to specify the following enhancements:
1. Specify SSB-less Secondary Cell (SCell) operation for inter-band Carrier Aggregation (CA) for FR1 and co-located cells, if found feasible by RAN4 study, where a User Equipment (UE) measures SSB transmitted on Primary Cell (PCell) or another SCell for an SCell's time/frequency synchronization (including downlink automatic gain control (AGC)), and L1/L3 measurements, including potential enhancement on SCell activation procedures if necessary.
2. Specify enhancement on cell discontinuous transmission/discontinuous reception (DTX/DRX) mechanism including the alignment of cell DTX or DRX and UE DRX in Radio Resource Control (RRC) CONNECTED mode, and inter-node information exchange on cell DTX/DRX:
   Note: No change for SSB transmission due to cell DTX/DRX.
   Note: The impact to IDLE/INACTIVE UEs due to the above enhancement should be avoided.
3. Specify the following techniques in spatial and power domains:
   Specify necessary enhancements on Channel State Information (CSI) and beam management related procedures including measurement and report, and signaling to enable efficient adaptation of spatial elements (e.g., antenna ports, active transceiver chains);
   Specify necessary enhancements on CSI related procedures including measurement and report, and signaling to enable efficient adaptation of power offset values between PDSCH and CSI-RS;
   Note: Above objectives are only for UE specific channels/signals; and
   Note: Legacy UE CSI/CSI-RS capabilities applies when considering total number of CSI reports and requirements.
4. Specify mechanism(s) to prevent legacy UEs camping on cells adopting the Rel-18 NES techniques, if necessary.
5. Specify conditional handover (CHO) procedure enhancement(s) in case source/target cell is in NES mode.
6. Specify inter-node beam activation and enhancements on restricting paging in a limited area.
7. Specify the corresponding Radio Resource Management/Radio Frequency (RRM/RF) core requirements, if necessary, for the above features.

### Conditional Handover (CHO)

When the radio link becomes degraded and the UE needs to send measurement reports, it is possible that those reports never reach the network since the uplink is degraded or even if they do, the network tries to respond with a handover command that may never reach the UE, either since the downlink is degraded.

To remedy these failure cases, CHO was introduced in 3GPP. The main motivation of this handover mechanism is to reduce the number of failure occurrences while a UE is moving, e.g., when a handover between cells fails, or when a connection fails even before a handover (HO) is triggered. In conditional handover, instead of preparing one target cell as in a regular (non-CHO) handover, one or more candidate target cells are prepared in advance in the network. This enables the network to send the handover command to the UE at an earlier stage compared to a regular handover, i.e., the handover command is sent when the radio conditions are still good, rather than when the radio conditions start to get degraded as in a regular handover. When received, the UE stores the handover command (and the RRC configurations included in the message), instead of applying it immediately, and starts to evaluate the CHO trigger condition(s) configured by the network. The UE only applies the stored handover command (and the associated RRC configuration) when the CHO trigger condition(s) configured by the network is satisfied for one of the configured candidate target cells. Then the UE executes the handover and connects to the target node as in a regular handover.

In conditional handover, instead of transmitting the measurement report, the UE applies the stored handover command message (and the associated RRC configuration) when the CHO trigger condition is satisfied for one of the configured candidate target cells. The network may also configure two CHO trigger conditions for the UE and associate both to the stored handover command, i.e., the handover command is applied only if both CHO trigger conditions are fulfilled, e.g., conditions configured for different types of measurement quantities, like cell coverage represented by Reference Signal Received Power (RSRP), and quality represented by Reference Signal Received Quality (RSRQ).

It is also possible that a failure is detected while the UE is monitoring the configured conditions. In legacy, the UE would perform cell selection and continue with a re-establishment procedure.

However, with conditional handover, when the same type of failure is detected, e.g., a radio link failure or handover failure, the UE can prioritize a cell for which it has a stored handover command and, instead of performing re-establishment, it performs a conditional handover, which reduces the interruption time and the signaling over the air interface.

As mentioned in the list above (#5), enhancements in CHO are proposed to target the NES scenarios. For example, a UE may be prepared with conditions related to a source/target gNB NES state where the term NES can be anything from a gNB completely turned off to a gNB operating in a relaxed manner with respect to one or more of time- (e.g., Cell DRX/DTX) and/or frequency- (operating with limited bandwidth), and/or power- (operating with reduced output power), and/or spatial (operating with fewer antennas) resources.

### Handover Failure

For intra-NR RAN handover, the source gNB triggers the Uu handover by sending an RRCReconfiguration message to the UE, containing the information required to access the target cell (including CellGroupConfig->spCellConfig->reconfigurationWithSync). The UE thus synchronizes to the target cell and completes the RRC handover procedure by sending RRCReconfigurationComplete message to target gNB.

However, there may be a failure in this handover process, in which case the UE will not be able to successfully complete random access on the target cell. Therefore, by the time the RRCReconfiguration message including reconfigurationWithSync is received, a timer is started (T304) and will continue to run until the UE successfully completes random access on the target cell.

If this timer expires, the UE will initiate RRC procedures for Reconfiguration with sync Failure, as defined in TS 38.331 and described below. Those procedures will store a variable with handover failure information which can be later requested by the network via UE information procedure as defined in TS 38.331, also described below:

5.3.5.8.3 T304 Expiry (Reconfiguration with Sync Failure)

The UE shall:

| | |
|---|---|
| 1> | if T304 of the MCG expires: |

| | |
|---|---|
| 2> | release dedicated preambles provided in rach-ConfigDedicated if configured; |
| 2> | revert back to the UE configuration used in the source PCell; |
| 2> | store the following handover failure information in VarRLF-Report by setting its fields |
| | as follows: |

| | |
|---|---|
| 3> | clear the information included in VarRLF-Report, if any; |
| 3> | set the plmn-IdentityList to include the list of EPLMNs stored by the UE (i.e. includes |
| | the RPLMN); |
| 3> | set the measResultLastServCell to include the RSRP, RSRQ and the available SINR, |
| | of the source PCell based on the available SSB and CSI-RS measurements collected |
| | up to the moment the UE detected handover failure; |
| 3> | set the ssbRLMConfigBitmap and/or csi-rsRLMConfigBitmap in |
| | measResultLastServCell to include the radio link monitoring configuration of the |
| | source PCell; |
| 3> | for each of the configured measObjectNR in which measurements are available; |

| | |
|---|---|
| 4> | if the SS/PBCH block-based measurement quantities are available; |

| | |
|---|---|
| 5> | set the measResultListNR in measResultNeighCells to include all the available |
| | measurement quantities of the best measured cells associated to the |
| | measObjectNR, other than the source PCell, ordered such that the cell with |
| | highest SS/PBCH block RSRP is listed first if SS/PBCH block RSRP |
| | measurement results are available, otherwise the cell with highest SS/PBCH |
| | block RSRQ is listed first if SS/PBCH block RSRQ measurement results are |
| | available, otherwise the cell with highest SS/PBCH block SINR is listed first, |
| | based on the available SS/PBCH block based measurements collected up to the |
| | moment the UE detected handover failure; |
| | 6> for each neighbor cell included, include the optional fields that are available; |

| | |
|---|---|
| 4> | if the CSI-RS based measurement quantities are available; |

| | |
|---|---|
| 5> | set the measResultListNR in measResultNeighCells to include all the available |
| | measurement quantities of the best measured cells, other than the source PCell, |
| | ordered such that the cell with highest CSI-RS RSRP is listed first if CSI-RS |
| | RSRP measurement results are available, otherwise the cell with highest CSI- |
| | RS RSRQ is listed first if CSI-RS RSRQ measurement results are available, |
| | otherwise the cell with highest CSI-RS SINR is listed first, based on the |
| | available CSI-RS based measurements collected up to the moment the UE |
| | detected handover failure; |
| | 6> for each neighbor cell included, include the optional fields that are available; |

| | |
|---|---|
| 3> | for each of the configured EUTRA frequencies in which measurements are available; |

| | |
|---|---|
| 4> | set the measResultListEUTRA in measResultNeighCells to include the best |
| | measured cells ordered such that the cell with highest RSRP is listed first if RSRP |
| | measurement results are available, otherwise the cell with highest RSRQ is listed |
| | first, and based on measurements collected up to the moment the UE detected |
| | radio link failure; |

| | |
|---|---|
| 5> | for each neighbor cell included, include the optional fields that are available; |

| | |
|---|---|
| NOTE 2: | The measured quantities are filtered by the L3 filter as configured in the mobility |

| | |
|---|---|
| | measurement configuration. The measurements are based on the time domain |
| | measurement resource restriction, if configured. Blacklisted cells are not required to |
| | be reported. |
| 3> | if detailed location information is available, set the content of the LocationInfo as |
| | follows: |

| | |
|---|---|
| 4> | if available, set the commonLocationInfo to include the detailed location |
| | information; |
| 4> | if available, set the bt-LocationInfo to include the Bluetooth measurement results, |
| | in order of decreasing RSSI for Bluetooth beacons; |
| 4> | if available, set the wlan-LocationInfo to include the WLAN measurement results, |
| | in order of decreasing RSSI for WLAN APs; |
| 4> | if available, set the sensor-LocationInfo to include the sensor measurement results; |

| | |
|---|---|
| 3> | set the failedPCellId to the global cell identity and tracking area code, if available, |
| | and otherwise to the physical cell identity and carrier frequency of the target PCell of |
| | the failed handover; |
| 3> | include previousPCellId and set it to the global cell identity and tracking area code of |
| | the PCell where the last RRCReconfiguration message including |
| | reconfigurationWithSync was received; |
| 3> | set the timeConnFailure to the elapsed time since reception of the last |
| | RRCReconfiguration message including the reconfigurationWithSync; |
| 3> | set the connectionFailureType to hof; |
| 3> | set the c-RNTI to the C-RNTI used in the source PCell; |
| 3> | set the absoluteFrequencyPointA to indicate the absolute frequency of the reference |
| | resource block associated to the random-access resources; |
| 3> | set the locationAndBandwidth and subcarrierSpacing associated to the UL BWP of |
| | the random-access resources; |
| 3> | set the msg1-FrequencyStart, msg1-FDM and msg1-SubcarrierSpacing associated to |
| | the random-access resources; |
| 3> | set perRAInfoList to indicate random access failure information as specified in |
| | 5.3.10.3; |

| | |
|---|---|
| 2> | initiate the connection re-establishment procedure as specified in subclause 5.3.7. |

| | |
|---|---|
| NOTE 1: | In the context above, “the UE configuration” includes state variables and |

parameters of each radio bearer.

| | |
|---|---|
| 1> | else if T304 of a secondary cell group expires: |

| | |
|---|---|
| 2> | release dedicated preambles provided in rach-ConfigDedicated, if configured; |
| 2> | initiate the SCG failure information procedure as specified in subclause 5.7.3 to report |
| | SCG reconfiguration with sync failure, upon which the RRC reconfiguration procedure |
| | ends; |

| | |
|---|---|
| 1> | else if T304 expires when RRCReconfiguration is received via other RAT (HO to NR |
| | failure): |

| | |
|---|---|
| 2> | reset MAC; |
| 2> | perform the actions defined for this failure case as defined in the specifications |
| | applicable for the other RAT. |

### 5.7.10 UE Information

### 5.7.10.1 General

The UE information procedure is used by NG-RAN to request the UE to report information.

### 5.7.x1.2 Initiation

NG-RAN initiates the procedure by sending the UEInformationRequest message. NG-RAN should initiate this procedure only after successful security activation.

5.7.x1.3 Reception of the UEInformationRequest message

Upon receiving the UEInformationRequest message, the UE shall, only after successful security activation:

| 1> | if the logMeasReportReq is present and if the RPLMN is included in plmn-IdentityList | |
|---|---|---|
| | stored in VarLogMeasReport: | |
| | 2> | if VarLogMeasReport includes one or more logged measurement entries, set the |
| | | contents of the logMeasReport in the UEInformationResponse message as follows: |

| 3> | include the absoluteTimeStamp and set it to the value of absoluteTimeInfo in the | |
|---|---|---|
| | VarLogMeasReport; | |
| 3> | | include the traceReference and set it to the value of traceReference in the |

| VarLogMeasReport; | |
|---|---|
| 3> | include the traceRecordingSessionRef and set it to the value of |
| | traceRecordingSessionRef in the VarLogMeasReport; |
| 3> | include the tce-Id and set it to the value of tce-Id in the VarLogMeasReport; |
| 3> | include the logMeasInfoList and set it to include one or more entries from |
| | VarLogMeasReport starting from the entries logged first; |
| 3> | if the VarLogMeasReport includes one or more additional logged measurement |
| | entries that are not included in the logMeasInfoList within the |
| | UEInformationResponse message: |

| | |
|---|---|
| 4> | include the logMeasAvailable; |

| | |
|---|---|
| 3> | if the VarLogMeasReport includes one or more additional logged Bluetooth |
| | measurement entries that are not included in the logMeasInfoList within the |
| | UEInformationResponse message: |

| | |
|---|---|
| 4> | include the logMeasAvailableBT; |

| | |
|---|---|
| 3> | if the VarLogMeasReport includes one or more additional logged WLAN |
| | measurement entries that are not included in the logMeasInfoList within the |
| | UEInformationResponse message: |

| | |
|---|---|
| 4> | include the logMeasAvailableWLAN; |

| 1> | if ra-ReportReq is set to true and the UE has random access related information available | |
|---|---|---|
| | in VarRA-Report and if the RPLMN is included in plmn-IdentityList stored in VarRA- | |
| | Report: | |
| | 2> | set the ra-Report in the UEInformationResponse message to the value of ra-Report in |
| | | VarRA-Report; |
| | 2> | discard the ra-Report from VarRA-Report upon successful delivery of the |
| | | UEInformationResponse message confirmed by lower layers; |
| 1> | if rlf-ReportReq is set to true: | |
| | 2> | if the UE has radio link failure information or handover failure information available in |
| | | VarRLF-Report and if the RPLMN is included in plmn-IdentityList stored in VarRLF- |
| | | Report: |

| | |
|---|---|
| 3> | set timeSinceFailure in VarRLF-Report to the time that elapsed since the last radio |
| | link or handover failure in NR; |
| 3> | set the rlf-Report in the UEInformationResponse message to the value of rlf-Report in |
| | VarRLF-Report; |
| 3> | discard the rlf-Report from VarRLF-Report upon successful delivery of the |
| | UEInformationResponse message confirmed by lower layers; |

| | |
|---|---|
| 2> | else if the UE has radio link failure information or handover failure information |
| | available in VarRLF-Report of TS 36.331 [10] and if the RPLMN is included in plmn- |
| | IdentityList stored in VarRLF-Report of TS 36.331 [10]: |

| | |
|---|---|
| 3> | set timeSinceFailure in VarRLF-Report of TS 36.331 [10] to the time that elapsed |
| | since the last radio link or handover failure in EUTRA; |
| 3> | set the rlf-Report in the UEInformationResponse message to the value of rlf-Report in |
| | VarRLF-Report; |
| 3> | discard the rlf-Report from VarRLF-Report upon successful delivery of the |
| | UEInformationResponse message confirmed by lower layers; |
| 3> | discard the rlf-Report from VarRLF-Report of TS 36.331 [10] upon successful |
| | delivery of the UEInformationResponse message confirmed by lower layers; |

| 1> | if connEstFailReportReq is set to true and the UE has connection establishment failure | |
|---|---|---|
| | information in VarConnEstFailReport and if the RPLMN is equal to plmn-Identity stored | |
| | in VarConnEstFailReport: | |
| | 2> | set timeSinceFailure in VarConnEstFailReport to the time that elapsed since the last |
| | | connection establishment failure in NR; |
| | 2> | set the connEstFailReport in the UEInformationResponse message to the value of |
| | | connEstFailReport in VarConnEstFailReport; |
| | 2> | discard the connEstFailReport from VarConnEstFailReport upon successful delivery of |
| | | the UEInformationResponse message confirmed by lower layers; |
| 1> | if the mobilityHistoryReportReq is set to true: | |
| | 2> | include the mobilityHistoryReport and set it to include entries from |
| | | VarMobilityHistoryReport; |
| | 2> | include in the mobilityHistoryReport an entry for the current cell, possibly after |
| | | removing the oldest entry if required, and set its fields as follows: |

| | |
|---|---|
| 3> | set visitedCellId to the global cell identity of the current cell: |
| 3> | set field timeSpent to the time spent in the current cell; |

| 1> | if the logMeasReport is included in the UEInformationResponse: | |
|---|---|---|
| | 2> | submit the UEInformationResponse message to lower layers for transmission via SRB2; |
| | 2> | discard the logged measurement entries included in the logMeasInfoList from |
| | | VarLogMeasReport upon successful delivery of the UEInformationResponse message |
| | | confirmed by lower layers; |
| 1> | else: | |
| | 2> | submit the UEInformationResponse message to lower layers for transmission via SRB1. |

### SUMMARY

Various embodiments disclosed herein provide for a method for configuring a User Equipment (UE) to store and report information related to performance degradation associated with Network Energy Savings (NES) features that are configured or active in the cell in which the UE is connected at the time of the performance degradation. The UE can receive a configuration to store and report the information, and then the UE can determine when an NES feature is activated or configured in the cell, and then when performance degradation occurs (e.g., radio link failure or handover failure) the UE can store the information and then report the information to a network node.

In an embodiment, a method is provided that is performed by a UE for storing and reporting information related to NES associated performance degradation. The method includes receiving a configuration from a network node that configures the UE to store and report information associated with performance degradation associated with NES. The method also includes determining that a cell associated with the UE has an NES feature activated. The method also includes storing the information associated with performance degradation. The method also includes providing a report to the network node that comprises the information associated with performance degradation and information related to the NES feature.

In an embodiment, a UE is provided that is configured to store and report information related to NES associated performance degradation. The UE includes a radio interface and processing circuitry configured to receive a configuration from a network node that configures the UE to store and report information associated with performance degradation associated with NES. The UE also determines that a cell associated with the UE has an NES feature activated. The UE also stores the information associated with performance degradation. The UE also provides a report to the network node that comprises the information associated with performance degradation and information related to the NES feature.

In an embodiment, a method is provided that is performed by a network node for configuring a UE to store and report information related to NES associated performance degradation. The method includes configuring the UE to store and report information associated with performance degradation associated with NES and receiving a report to the network node that comprises the information associated with performance degradation and information related to the NES feature. The method also includes performing a network operation based on the report.

In an embodiment, a network node is provided that is configured to configure a UE to store and report information related to NES associated performance degradation, the UE comprising a radio interface and processing circuitry configured to configure the UE to store and report information associated with performance degradation associated with NES; receive a report to the network node that comprises the information associated with performance degradation and information related to the NES feature; and perform a network operation based on the report.

Certain embodiments may provide one or more of the following technical advantage(s). The present disclosure enables networks to know whether a NES mode (or a configuration of a NES feature) would have detrimental effects on Quality of Experience (QoE) or another Key Performance Indicator (KPI) for a certain UE or service type.

Based on the UE report, the network can take actions to mitigate the handover failures (e.g., the serving cell may choose to change its own scheme, inform the neighbor/target gNB via NW internal interfaces to change its NES scheme) or take distinct handover decisions to avoid failure, which can increase the likelihood of successful and low-latency handovers.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows an example of a communication system 100 in accordance with some embodiments;

FIG. 2 illustrates a message sequence chart between a User Equipment (UE) and one or more network nodes for configuring the UE to store and report information related to performance degradation according to one or more embodiments of the present disclosure;

FIG. 3 shows a UE 300 in accordance with some embodiments;

FIG. 4 shows a network node 400 in accordance with some embodiments;

FIG. 5 is a block diagram of a host, which may be an embodiment of the host of FIG. 1, in accordance with various aspects described herein; and

FIG. 6 is a block diagram illustrating a virtualization environment in which functions implemented by some embodiments may be virtualized.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). The handover procedure in New Radio (NR) may fail due to a cell applying a Network Energy Savings (NES) technique, e.g., Uplink/Downlink (UL/DL) degradation may prevent the User Equipment (UE) from successfully completing the random access on the target cell if the target cell is applying cell Discontinuous Transmission (DTX) or Discontinuous Reception (DRX). For example, the cell in NES mode may have less Physical Random Access Channel (PRACH) occasions, or Synchronization Signal Blocks (SSBs) allocated to PRACH occasions. There may also be SSBs transmitted with less antenna ports and/or with less transmission power. In addition, if cell ON time is limited and dimensioned to serve UEs already in the cell, the new coming UE may not get response to Random Access Channel (RACH) procedure within the response window. However, currently the UE cannot report a handover failure associated to a NES technique. Hence the network cannot take into account NES technique issues to tackle handover failure.

Certain aspects of the disclosure and their embodiments may provide solutions to these or other challenges. When the gNodeB (gNB) aims to go into a NES mode, and if the NES mode is such that it might affect certain services/UEs negatively, the gNB may retrieve from the UE a report of procedure failures or observed performance degradations related to NES mode. The UE could initially store such information, which can include the configuration of the failed or degraded procedure and the currently configured NES settings, and transmit a report upon gNB request. The gNB may then use the report to determine whether to activate the NES mode and/or how aggressively to configure it.

The NES-related reporting may be applied to various failure or performance degradation instances, e.g. handover failures (incl. conditional handover (CHO)), Random Access (RA) failures or latency increase, data scheduling latency increase or reduced TP, Scell latency or availability degradation, etc.

Various embodiments disclosed herein provide for a method for configuring a UE to store and report information related to performance degradation associated with NES features that are configured or active in the cell in which the UE is connected at the time of the performance degradation. The UE can receive a configuration to store and report the information, and then the UE can determine when an NES feature is activated or configured in the cell, and then when performance degradation occurs (e.g., radio link failure or handover failure) the UE can store the information and then report the information to a network node.

Certain embodiments may provide one or more of the following technical advantage(s). The present disclosure enables networks to know whether a NES mode (or a configuration of a NES feature) would have detrimental effects on Quality of Experience (QoE) or another Key Performance Indicator (KPI) for a certain UE or service type.

Based on the UE report, the network can take actions to mitigate the handover failures (e.g., the serving cell may choose to change its own scheme, inform the neighbor/target gNB via NW internal interfaces to change its NES scheme) or take distinct handover decisions to avoid failure, which can increase the likelihood of successful and low-latency handovers.

The method can also assist the target node, during handover, to create an RRC configuration that is tailored to the interference condition that a UE experiences. For instance, if the target node is made aware of cells the UE attempted to handover but failed due to the NES mode on those cells, the target node can decide to configure the UE with a cell that is not reported as handover failure.

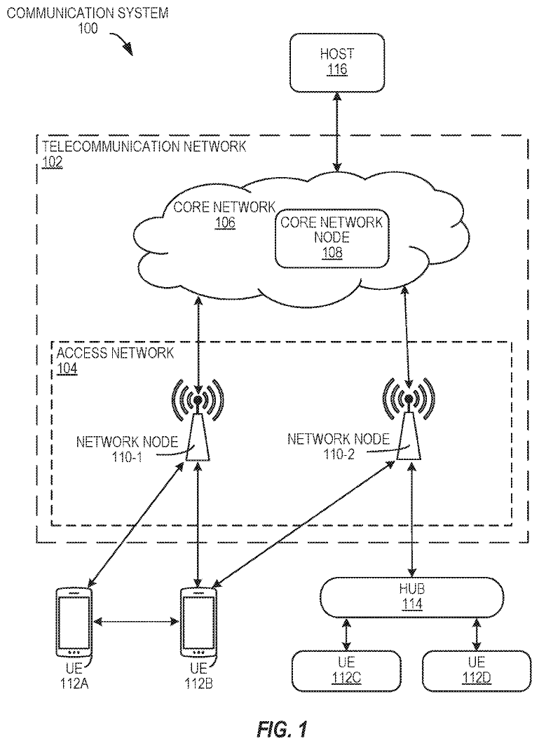

FIG. 1 shows an example of a communication system 100 in accordance with some embodiments.

In the example, the communication system 100 includes a telecommunication network 102 that includes an access network 104, such as a Radio Access Network (RAN), and a core network 106, which includes one or more core network nodes 108. The access network 104 includes one or more access network nodes, such as network nodes 110-1 and 110-2 (one or more of which may be generally referred to as network nodes 110), or any other similar Third Generation Partnership Project (3GPP) access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 102 includes one or more Open-RAN (ORAN) network nodes. An ORAN network node is a node in the telecommunication network 102 that supports an ORAN specification (e.g., a specification published by the O-RAN Alliance, or any similar organization) and may operate alone or together with other nodes to implement one or more functionalities of any node in the telecommunication network 102, including one or more network nodes 110 and/or core network nodes 108.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 110 facilitate direct or indirect connection of UE, such as by connecting UEs 112A, 112B, 112C, and 112D (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one or more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102 and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 1 enables connectivity between the UEs, network nodes, and hosts. In that sense, the communication system 100 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 102 is a cellular network that implements 3GPP standardized features. Accordingly, the telecommunication network 102 may support network slicing to provide different logical networks to different devices that are connected to the telecommunication network 102. For example, the telecommunication network 102 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-Radio Access Technology (RAT) or multi-standard mode. For example, a UE may operate with any one or combination of WiFi, New Radio (NR), and LTE, i.e. being configured for Multi-Radio Dual Connectivity (MR-DC), such as Evolved UMTS Terrestrial RAN (E-UTRAN) NR-Dual Connectivity (EN-DC).

In the example, a hub 114 communicates with the access network 104 to facilitate indirect communication between one or more UEs (e.g., UE 112C and/or 112D) and network nodes (e.g., network node 110-2). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a Virtual Reality (VR) headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110-2. The hub 114 may also allow for a different communication scheme and/or schedule between the hub 114 and UEs (e.g., UE 112C and/or 112D), and between the hub 114 and the core network 106. In other examples, the hub 114 is connected to the core network 106 and/or one or more UEs via a wired connection. Moreover, the hub 114 may be configured to connect to a Machine-to-Machine (M2M) service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110-2. In other embodiments, the hub 114 may be a non-dedicated hub—that is, a device which is capable of operating to route communications between the UEs and the network node 110-2, but which is additionally capable of operating as a communication start and/or end point for certain data channels.

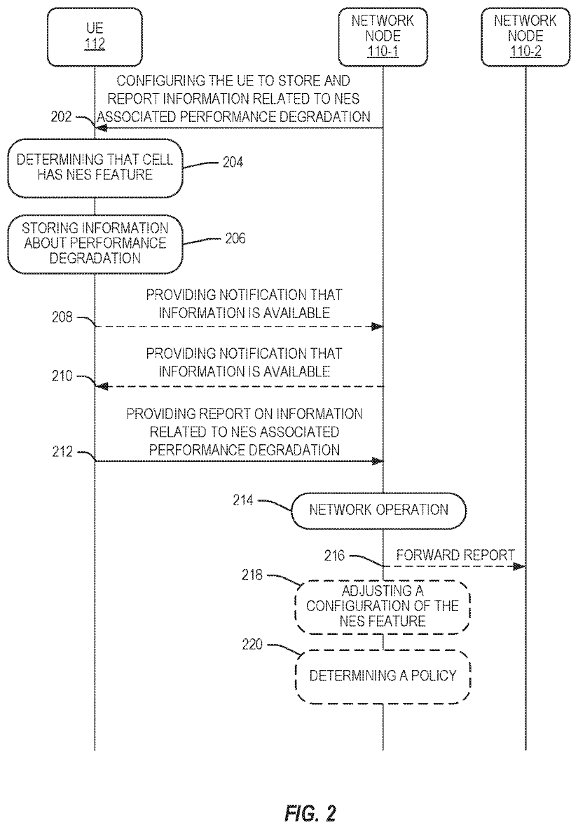

FIG. 2 illustrates a message sequence chart between a UE 112 and one or more network node 110-1 and 110-2 for configuring the UE 112 to store and report information related to performance degradation that is due to NES features being activated or configured for the cell in which UE 112 is connected. It is to be appreciated that the dashed lines and boxes represent steps in the message sequence chart that are optional.

At 202, the network node 110-1 (by example, although network node 110-2 can also perform this step in other embodiments) can configure the UE to store and report information related to NES associated performance degradation. The configuration that is received can be through an independent higher layer signaling, e.g., a RRC configuration or reconfiguration message, it can be an implicit configuration. The configuration can be implicit in the case when the UE 112 is already configured for conditional handover (CHO) related to NES, and an implicit configuration may be that a HO failure report is already automatically configured.

The performance impact may be Radio Link Failure related to NES e.g. in case of handover failure, where the configuration can also be provided as part of the configuration of CHO related to NES, and an implicit configuration may include that e.g., if CHO for NES is configured, the feature, i.e., HO failure report is automatically configured.

At 204, the UE 112 can determine that NES related information is available; E.g., the UE may be informed or indicated, e.g., in System Information (SI) that a cell impacting NES feature is configured, enabled or activated. The NES feature could be one or more of wherein the NES feature is at least one of: a network node antenna or power adaptation; a discontinuous transmission or discontinuous reception configuration; or a network node Physical Random Access Channel configuration.

E.g., in detail, that SSBs are impacted by antenna or power adaptation, or cell DTX/DRX is active and it may be that SSBs are not transmitted during the inactive time, or that the gNB does not listen to PRACH occasions during the inactive time, or that it listens to PRACH but in a sparser configuration, or the NW applies adaptive PRACH occasions, i.e., not all configured PRACH occasions may be listened to by the NW, or at a higher level, that SSB transmission or PRACH reception may be degraded

At 206, the UE 112 can store NES related information when noting the performance degradation. The UE 112 can also store an indication of the UE configuration settings and the time at which the performance degradation occurred in addition to information about the NES. For example, for Radio Link Failure (RLF); in addition to mentioning the RLF, the UE can store information that a first RLF has occurred while a first or second NES feature was configured, enabled, activated or indicated.

Optionally, at 208, the UE 112 can provide a notification to the network node 110-1 that the NES report information is available. The notification can be provided via an RRC complete message indicating that NES report information related to the performance degradation is available. The notification can be provided to the network node that is responsible for the NES feature or the performance degradation. Alternatively, the notification can also be provided to a master network node that may configure the network node responsible for the NES feature.

Additionally, at 210, the UE 112 can receive an indication to report the performance degradation related to NES operation; the indication can be an RRC message, e.g., as part of the RRCreconfiguration, or a L1/L2 based indication, e.g., downlink control information (DCI) or a medium access control control element (MAC-CE). The form of indication itself can be configured through higher layers, particularly if the indication is a L1/L2 based signaling. E.g., the handover information is to be included in the report.

At 212, the UE 112 can provide to network node 110-1 (e.g., to the Master Node) a report to the network node (110-1) that comprises the information associated with performance degradation and information related to the NES feature. The report can include the collected degradation info related to NES and the associated NES configuration settings at the time. E.g., the handover information is provided in the report.

In one embodiment, the network node 110-1 receives the reports at 212 regarding RLF or HO failures, and shares the outcome with one or more other nodes, e.g., network node 110-2 at step 216 configured with a NES feature, particularly if the network node 110-2 was the node for which the UE has reported a HO failure.

In another embodiment, the node for which the UE has reported a HO failure (e.g., network node 110-1 in an embodiment) can use the last received report to adjust, at step 218, the next configuration of an NES feature that caused the failure or perform another action to mitigate future HO failures.

In another embodiment, the node for which the UE has reported a HO failure can keep track of HO failure reports and use the stored information for determining, at step 220, a policy that mitigates future HO failures.

In one example the node can use the HO failure records to modify or cancel the configuration of a NES feature that caused the failure based on a simple policy (i.e., the configuration of a NES feature is modified or cancelled if the number of failures excided a predefined threshold).

In another example, the network node 110-1 node can use a learning-based algorithm that determines the policy for mitigating future HO failures. The learning architecture can be centralized (i.e., limited to one node) or distributed (i.e., spread across multiple nodes).

Further examples of the solution for handover case.

This solution enables a framework for NES related information to be retrieved by the network. Although the framework can be applied in multiple scenarios of UE performance degradation related to NES, further examples are given below for handover case.

In handover failure case, in order to allow for the network to establish the reason that handover failure or partial degradation of the handover and/or delays of handover occurs, in one embodiment the UE includes NES related information in the RLF report after handover failure, if available, and indicates to the network that it has NES related reports available. Hence, the network may retrieve those NES related reports from the UE to know whether NES operations may be the cause of the handover failure.

The UE can implicitly indicate that NES related reports may be available by indicating availability of the RLF report; similarly, the network would implicitly request for NES related report by requesting for the UE available RLF report;

Alternatively, in order to allow more distinction, in one embodiment the UE may include the NES related information in a dedicated failure report (i.e. not included in the RLF report). In that case, the UE would explicitly indicate to the network that is has a failure report related to NES; similarly, the network would explicitly request such NES related information;

The network may also proactively request from the UE a failure report including NES related information (either implicit report within RLF report or explicit report only for NES related information).

NES related information can be any of: UE indication in whether particular measurements are related to a cell applying a NES mode or not (this could be retrieved e.g., if the NES mode is advertised in the cell); CHO info related to NES. The CHO configuration may contain particular fields for NES which can identify that CHO configuration is related to NES cells, e.g., specific triggering conditions; If UE receives an RRC configuration from target cell containing any cell NES configuration, the UE can identify that cell as applying a NES configuration and include a flag in its failure report for the measurements of that cell to further identify that cell as applying a NES configuration; When configuring the UE to generate reports for NES related HO failure, the NW can configure specific frequencies where it expects NES configuration to be applied, or specific NES types of configuration. When receiving the UE report, the NW can derive from this indication which UE measured frequencies are applying NES techniques; UE may also indicate in the report if UE had chosen a second or third best candidate target cell (measured in RSRP or RSRQ based cell quality derivation) configured in the CHO command due to the best or second best cell applying a NES mode and hence being deprioritized by the UE. This information may be in the failure report in case the HO failed, or in the RRC complete message in case the HO was successful.

FIG. 3 shows a UE 300 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle, vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 300 includes processing circuitry 302 that is operatively coupled via a bus 304 to an input/output interface 306, a power source 308, memory 310, a communication interface 312, and/or any other component, or any combination thereof. Certain UEs may utilize all or a subset of the components shown in FIG. 3. The level of integration between the components may vary from one UE to another UE. Further, certain UEs may contain multiple instances of a component, such as multiple processors, memories, transceivers, transmitters, receivers, etc.

The processing circuitry 302 is configured to process instructions and data and may be configured to implement any sequential state machine operative to execute instructions stored as machine-readable computer programs in the memory 310. The processing circuitry 302 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 302 may include multiple Central Processing Units (CPUs).

In the example, the input/output interface 306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 308 is structured as a battery or battery pack. Other types of power sources, such as an external power source (e.g., an electricity outlet), photovoltaic device, or power cell, may be used. The power source 308 may further include power circuitry for delivering power from the power source 308 itself, and/or an external power source, to the various parts of the UE 300 via input circuitry or an interface such as an electrical power cable. Delivering power may be, for example, for charging of the power source 308. Power circuitry may perform any formatting, converting, or other modification to the power from the power source 308 to make the power suitable for the respective components of the UE 300 to which power is supplied.

The memory 310 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 310 includes one or more application programs 314, such as an operating system, web browser application, a widget, gadget engine, or other application, and corresponding data 316. The memory 310 may store, for use by the UE 300, any of a variety of various operating systems or combinations of operating systems.

The memory 310 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 310 may allow the UE 300 to access instructions, application programs, and the like stored on transitory or non-transitory memory media, to off-load data, or to upload data. An article of manufacture, such as one utilizing a communication system, may be tangibly embodied as or in the memory 310, which may be or comprise a device-readable storage medium.

The processing circuitry 302 may be configured to communicate with an access network or other network using the communication interface 312. The communication interface 312 may comprise one or more communication subsystems and may include or be communicatively coupled to an antenna 322. The communication interface 312 may include one or more transceivers used to communicate, such as by communicating with one or more remote transceivers of another device capable of wireless communication (e.g., another UE or a network node in an access network). Each transceiver may include a transmitter 318 and/or a receiver 320 appropriate to provide network communications (e.g., optical, electrical, frequency allocations, and so forth). Moreover, the transmitter 318 and receiver 320 may be coupled to one or more antennas (e.g., the antenna 322) and may share circuit components, software, or firmware, or alternatively be implemented separately.

In the illustrated embodiment, communication functions of the communication interface 312 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 300 shown in FIG. 3.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

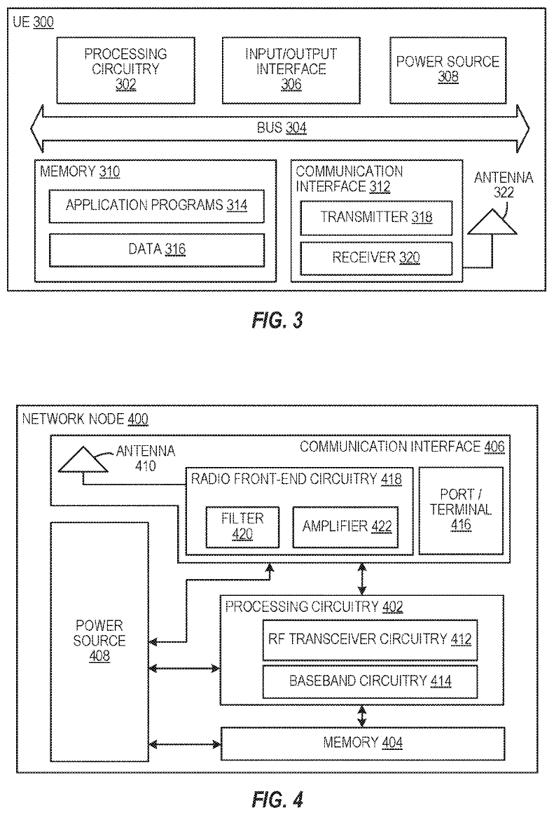

FIG. 4 shows a network node 400 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), NR Node Bs (gNBs)), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 400 includes processing circuitry 402, memory 404, a communication interface 406, and a power source 408. The network node 400 may be composed of multiple physically separate components (e.g., a NodeB component and an RNC component, or a BTS component and a BSC component, etc.), which may each have their own respective components. In certain scenarios in which the network node 400 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, the network node 400 may be configured to support multiple RATs. In such embodiments, some components may be duplicated (e.g., separate memory 404 for different RATs) and some components may be reused (e.g., a same antenna 410 may be shared by different RATs). The network node 400 may also include multiple sets of the various illustrated components for different wireless technologies integrated into network node 400, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 400.

The processing circuitry 402 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 400 components, such as the memory 404, to provide network node 400 functionality.

In some embodiments, the processing circuitry 402 includes a System on a Chip (SOC). In some embodiments, the processing circuitry 402 includes one or more of Radio Frequency (RF) transceiver circuitry 412 and baseband processing circuitry 414. In some embodiments, the RF transceiver circuitry 412 and the baseband processing circuitry 414 may be on separate chips (or sets of chips), boards, or units, such as radio units and digital units. In alternative embodiments, part or all of the RF transceiver circuitry 412 and the baseband processing circuitry 414 may be on the same chip or set of chips, boards, or units.

The memory 404 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 402. The memory 404 may store any suitable instructions, data, or information, including a computer program, software, an application including one or more of logic, rules, code, tables, and/or other instructions capable of being executed by the processing circuitry 402 and utilized by the network node 400. The memory 404 may be used to store any calculations made by the processing circuitry 402 and/or any data received via the communication interface 406. In some embodiments, the processing circuitry 402 and the memory 404 are integrated.

The communication interface 406 is used in wired or wireless communication of signaling and/or data between a network node, access network, and/or UE. As illustrated, the communication interface 406 comprises port(s)/terminal(s) 416 to send and receive data, for example to and from a network over a wired connection. The communication interface 406 also includes radio front-end circuitry 418 that may be coupled to, or in certain embodiments a part of, the antenna 410. The radio front-end circuitry 418 comprises filters 420 and amplifiers 422. The radio front-end circuitry 418 may be connected to the antenna 410 and the processing circuitry 402. The radio front-end circuitry 418 may be configured to condition signals communicated between the antenna 410 and the processing circuitry 402. The radio front-end circuitry 418 may receive digital data that is to be sent out to other network nodes or UEs via a wireless connection. The radio front-end circuitry 418 may convert the digital data into a radio signal having the appropriate channel and bandwidth parameters using a combination of the filters 420 and/or the amplifiers 422. The radio signal may then be transmitted via the antenna 410. Similarly, when receiving data, the antenna 410 may collect radio signals which are then converted into digital data by the radio front-end circuitry 418. The digital data may be passed to the processing circuitry 402. In other embodiments, the communication interface 406 may comprise different components and/or different combinations of components.

In certain alternative embodiments, the network node 400 does not include separate radio front-end circuitry 418; instead, the processing circuitry 402 includes radio front-end circuitry and is connected to the antenna 410. Similarly, in some embodiments, all or some of the RF transceiver circuitry 412 is part of the communication interface 406. In still other embodiments, the communication interface 406 includes the one or more ports or terminals 416, the radio front-end circuitry 418, and the RF transceiver circuitry 412 as part of a radio unit (not shown), and the communication interface 406 communicates with the baseband processing circuitry 414, which is part of a digital unit (not shown).

The antenna 410 may include one or more antennas, or antenna arrays, configured to send and/or receive wireless signals. The antenna 410 may be coupled to the radio front-end circuitry 418 and may be any type of antenna capable of transmitting and receiving data and/or signals wirelessly. In certain embodiments, the antenna 410 is separate from the network node 400 and connectable to the network node 400 through an interface or port.

The antenna 410, the communication interface 406, and/or the processing circuitry 402 may be configured to perform any receiving operations and/or certain obtaining operations described herein as being performed by the network node 400. Any information, data, and/or signals may be received from a UE, another network node, and/or any other network equipment. Similarly, the antenna 410, the communication interface 406, and/or the processing circuitry 402 may be configured to perform any transmitting operations described herein as being performed by the network node 400. Any information, data, and/or signals may be transmitted to a UE, another network node, and/or any other network equipment.

The power source 408 provides power to the various components of the network node 400 in a form suitable for the respective components (e.g., at a voltage and current level needed for each respective component). The power source 408 may further comprise, or be coupled to, power management circuitry to supply the components of the network node 400 with power for performing the functionality described herein. For example, the network node 400 may be connectable to an external power source (e.g., the power grid or an electricity outlet) via input circuitry or an interface such as an electrical cable, whereby the external power source supplies power to power circuitry of the power source 408. As a further example, the power source 408 may comprise a source of power in the form of a battery or battery pack which is connected to, or integrated in, power circuitry. The battery may provide backup power should the external power source fail.

Embodiments of the network node 400 may include additional components beyond those shown in FIG. 4 for providing certain aspects of the network node's functionality, including any of the functionality described herein and/or any functionality necessary to support the subject matter described herein. For example, the network node 400 may include user interface equipment to allow input of information into the network node 400 and to allow output of information from the network node 400. This may allow a user to perform diagnostic, maintenance, repair, and other administrative functions for the network node 400.

FIG. 5 is a block diagram of a host 500, which may be an embodiment of the host 116 of FIG. 1, in accordance with various aspects described herein. As used herein, the host 500 may be or comprise various combinations of hardware and/or software including a standalone server, a blade server, a cloud-implemented server, a distributed server, a virtual machine, container, or processing resources in a server farm. The host 500 may provide one or more services to one or more UEs.

The host 500 includes processing circuitry 502 that is operatively coupled via a bus 504 to an input/output interface 506, a network interface 508, a power source 510, and memory 512. Other components may be included in other embodiments. Features of these components may be substantially similar to those described with respect to the devices of previous figures, such as FIGS. 3 and 4, such that the descriptions thereof are generally applicable to the corresponding components of the host 500.

The memory 512 may include one or more computer programs including one or more host application programs 514 and data 516, which may include user data, e.g. data generated by a UE for the host 500 or data generated by the host 500 for a UE. Embodiments of the host 500 may utilize only a subset or all of the components shown. The host application programs 514 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 514 may also provide for user authentication and licensing checks and may periodically report health, routes, and content availability to a central node, such as a device in or on the edge of a core network. Accordingly, the host 500 may select and/or indicate a different host for Over-The-Top (OTT) services for a UE. The host application programs 514 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

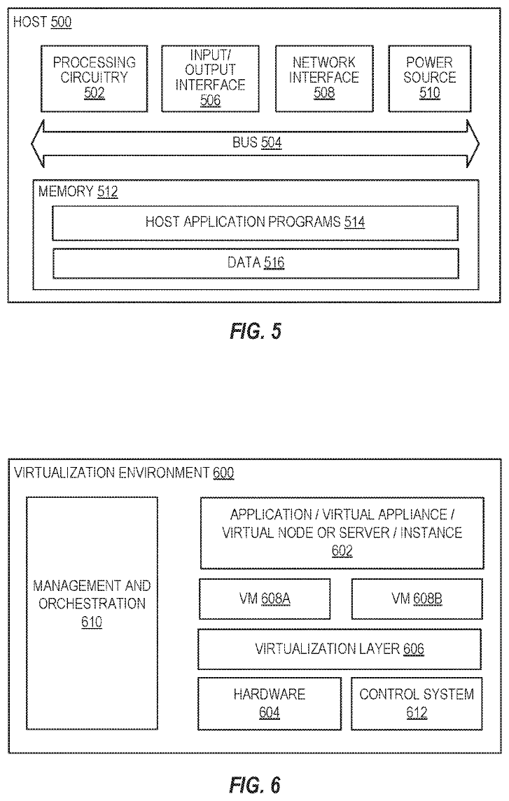

FIG. 6 is a block diagram illustrating a virtualization environment 600 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 600 includes components defined by the O-RAN Alliance, such as an O-Cloud environment orchestrated by a Service Management and Orchestration Framework via an O-2 interface.

Applications 602 (which may alternatively be called software instances, virtual appliances, network functions, virtual nodes, virtual network functions, etc.) are run in the virtualization environment 600 to implement some of the features, functions, and/or benefits of some of the embodiments disclosed herein.

Hardware 604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 606 (also referred to as hypervisors or VM Monitors (VMMs)), provide VMs 608A and 608B (one or more of which may be generally referred to as VMs 608), and/or perform any of the functions, features, and/or benefits described in relation with some embodiments described herein. The virtualization layer 606 may present a virtual operating platform that appears like networking hardware to the VMs 608.

The VMs 608 comprise virtual processing, virtual memory, virtual networking, or interface and virtual storage, and may be run by a corresponding virtualization layer 606. Different embodiments of the instance of a virtual appliance 602 may be implemented on one or more of the VMs 608, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 608 may be a software implementation of a physical machine that runs programs as if they were executing on a physical, non-virtualized machine. Each of the VMs 608, and that part of the hardware 604 that executes that VM, be it hardware dedicated to that VM and/or hardware shared by that VM with others of the VMs 608, forms separate virtual network elements. Still in the context of NFV, a virtual network function is responsible for handling specific network functions that run in one or more VMs 608 on top of the hardware 604 and corresponds to the application 602.

The hardware 604 may be implemented in a standalone network node with generic or specific components. The hardware 604 may implement some functions via virtualization. Alternatively, the hardware 604 may be part of a larger cluster of hardware (e.g., such as in a data center or CPE) where many hardware nodes work together and are managed via management and orchestration 610, which, among others, oversees lifecycle management of the applications 602. In some embodiments, the hardware 604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 612 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

Some of the embodiments of the present disclosure include the following.

Embodiment 1: A method performed by a User Equipment device, UE, (112) for storing and reporting information related to Network Energy Savings, NES, associated performance degradation, the method comprising: receiving (202) a configuration from a network node (110-1) that configures the UE (112) to store and report information associated with performance degradation associated with NES; determining (204) that a cell associated with the UE (112) has an NES feature activated; storing (206) the information associated with performance degradation; and providing (212) a report to the network node (110-1) that comprises the information associated with performance degradation and information related to the NES feature.

Embodiment 2: The method of embodiment 1, further comprising: providing (208) a notification to the network node (110-1) that the information associated with the performance degradation is available; and receiving (210) a request to provide the report to the network node (110-1).

Embodiment 3: The method of embodiment 2, wherein the request to provide the report to the network node (110-1) is provided via at least one of: a radio resource control message; downlink control information; or a medium access control, MAC, control element, CE.

Embodiment 4: The method of any of embodiments 1 to 3, wherein the information associated with performance degradation is information about at least one a radio link failure or a handover failure.

Embodiment 5: The method of any of embodiments 1 to 4, wherein the receiving a configuration is based on at least one of an implicit configuration, a configuration message, or a reconfiguration message.

Embodiment 6: The method of embodiment 5, wherein the implicit configuration is based on a configuration for conditional handover for NES.

Embodiment 7: The method of any of embodiments 1 to 6, wherein the determining that the cell associated with the UE (112) has the NES feature activated is based on system information indicating the NES feature.

Embodiment 8: The method of any of embodiments 1 to 7, wherein the NES feature is at least one of: a network node antenna or power adaptation; a discontinuous transmission or discontinuous reception configuration; or a network node Physical Random Access Channel configuration.

Embodiment 9: The method of any of embodiments 1 to 8, wherein the information associated with performance degradation includes information identifying that the NES feature was active at a time of the performance degradation.

Embodiment 10: The method of any of embodiments 1 to 9, wherein the network node (110-1) is different than another network node (110-2) associated with the cell that has the NES feature activated.

Embodiment 11: A User Equipment device, UE, (112) configured to store and report information related to Network Energy Savings, NES, associated performance degradation, the UE (112) comprising a radio interface and processing circuitry configured to: receive (202) a configuration from a network node (110-1) that configures the UE (112) to store and report information associated with performance degradation associated with NES; determine (204) that a cell associated with the UE (112) has an NES feature activated; store (206) the information associated with performance degradation; and provide (212) a report to the network node (110-1) that comprises the information associated with performance degradation and information related to the NES feature.

Embodiment 12: The UE (112) of embodiment 11, wherein the processing circuitry is further configured to: provide (208) a notification to the network node (110-1) that the information associated with the performance degradation is available; and receive (210) a request to provide the report to the network node (110-1).

Embodiment 13: The UE (112) of embodiment 12, wherein the request to provide the report to the network node (110-1) is provided via at least one of: a radio resource control message; downlink control information; or a medium access control, MAC, control element, CE.

Embodiment 14: The UE (112) of any of embodiments 11 to 13, wherein the information associated with performance degradation is information about at least one a radio link failure or a handover failure.

Embodiment 15: The UE (112) of any of embodiments 11 to 14, wherein the receiving a configuration is based on at least one of an implicit configuration, a configuration message, or a reconfiguration message.

Embodiment 16: The UE (112) of embodiment 15, wherein the implicit configuration is based on a configuration for conditional handover for NES.

Embodiment 17: The UE (112) of any of embodiments 11 to 16, wherein the determining that the cell associated with the UE (112) has the NES feature activated is based on system information indicating the NES feature.

Embodiment 18: The UE (112) of any of embodiments 11 to 17, wherein the NES feature is at least one of: a network node antenna or power adaptation; a discontinuous transmission or discontinuous reception configuration; or a network node Physical Random Access Channel configuration.

Embodiment 19: The UE (112) of any of embodiments 11 to 18, wherein the information associated with performance degradation includes information identifying that the NES feature was active at a time of the performance degradation.

Embodiment 20: The UE (112) of any of embodiments 11 to 19, wherein the network node (110-1) is different than another network node (110-2) associated with the cell that has the NES feature activated.

Embodiment 21: A method performed by a network node (110-1) for configuring a User Equipment device, UE, (112) to store and report information related to Network Energy Savings, NES, associated performance degradation, the method comprising: configuring (202) the UE (112) to store and report information associated with performance degradation associated with NES; receiving (212) a report to the network node (110-1) that comprises the information associated with performance degradation and information related to the NES feature; and performing (214) a network operation based on the report.

Embodiment 22: The method of embodiment 21, wherein the performing (214) the network operation further comprises: forwarding (216) the report to another network node associated with the cell that has the NES feature activated.

Embodiment 23: The method of embodiment 21, wherein the performing the network operation further comprises: adjusting (218) a configuration of the NES feature activated based on the report.

Embodiment 24: The method of embodiment 21, wherein the performing the network operation further comprises: adjusting (218) a configuration of the NES feature activated based on previous reports.

Embodiment 25: The method of embodiment 24, wherein the adjusting the configuration can comprise modifying or disabling the NES feature in response to receiving a predetermined number of reports.

Embodiment 26: The method of embodiment 24, further comprising: determining (220) a policy based on the previous reports.

Embodiment 27: The method of any of embodiments 21 to 26, further comprising: receiving (208) a notification from the UE (112) that the information associated with the performance degradation is available; and providing (210) a request to provide the report to the network node (110-1).

Embodiment 28: The method of any of embodiments 21 to 27, wherein the information associated with performance degradation is information about at least one a radio link failure or a handover failure.

Embodiment 29: The method of any of embodiments 21 to 28, wherein the NES feature is at least one of: a network node antenna or power adaptation; a discontinuous transmission or discontinuous reception configuration; or a network node Physical Random Access Channel configuration.

Embodiment 30: A network node (110-1) configured to configure a User Equipment device, UE, (112) to store and report information related to Network Energy Savings, NES, associated performance degradation, the UE comprising a radio interface and processing circuitry configured to: configure (202) the UE (112) to store and report information associated with performance degradation associated with NES; receive (212) a report to the network node (110-1) that comprises the information associated with performance degradation and information related to the NES feature; and perform (214) a network operation based on the report.

Embodiment 31: The network node (110-1) of embodiment 30, wherein the processing circuitry is further configured to: forward (216) the report to another network node associated with the cell that has the NES feature activated.

Embodiment 32: The network node (110-1) of embodiment 30, wherein the processing circuitry is further configured to: adjust (218) a configuration of the NES feature activated based on the report.

Embodiment 33: The network node (110-1) of embodiment 30, wherein the processing circuitry is further configured to: adjust (218) a configuration of the NES feature activated based on previous reports.

Embodiment 34: The network node (110-1) of embodiment 33, wherein the adjusting the configuration can comprise modifying or disabling the NES feature in response to receiving a predetermined number of reports.

Embodiment 35: The network node (110-1) of embodiment 33, wherein the processing circuitry is further configured to: determine (220) a policy based on the previous reports.

Embodiment 36: The network node (110-1) of any of embodiments 30 to 35, wherein the processing circuitry is further configured to: receive (208) a notification from the UE (112) that the information associated with the performance degradation is available; and provide (210) a request to provide the report to the network node (110-1).

Embodiment 37: The network node (110-1) of any of embodiments 30 to 36, wherein the information associated with performance degradation is information about at least one a radio link failure or a handover failure.

Embodiment 38: The network node (110-1) of any of embodiments 30 to 37, wherein the NES feature is at least one of: a network node antenna or power adaptation; a discontinuous transmission or discontinuous reception configuration; or a network node Physical Random Access Channel configuration.

Those skilled in the art will recognize improvements and modifications to the embodiments of the present disclosure. All such improvements and modifications are considered within the scope of the concepts disclosed herein.

1. A method performed by a User Equipment device, UE, for storing and reporting information related to Network Energy Savings, NES, associated performance degradation, the method comprising:
receiving a configuration from a network node that configures the UE to store and report information associated with performance degradation associated with NES;
determining that a cell associated with the UE has an NES feature activated;
storing the information associated with performance degradation; and
providing a report to the network node that comprises the information associated with performance degradation and information related to the NES feature.

2. The method of claim 1, further comprising:
providing a notification to the network node that the information associated with the performance degradation is available; and
receiving a request to provide the report to the network node.

3. The method of claim 2, wherein the request to provide the report to the network node is provided via at least one of:
a radio resource control message;
downlink control information; or
a medium access control, MAC, control element, CE.

4. The method of claim 1, wherein the information associated with performance degradation is information about at least one a radio link failure or a handover failure.

5. The method of claim 1, wherein the receiving a configuration is based on at least one of an implicit configuration, a configuration message, or a reconfiguration message.

6. The method of claim 5, wherein the implicit configuration is based on a configuration for conditional handover for NES.

7. The method of claim 1, wherein the determining that the cell associated with the UE has the NES feature activated is based on system information indicating the NES feature.

8. The method of claim 1, wherein the NES feature is at least one of:
a network node antenna or power adaptation;
a discontinuous transmission or discontinuous reception configuration; or
a network node Physical Random Access Channel configuration.

9. The method of claim 1, wherein the information associated with performance degradation includes information identifying that the NES feature was active at a time of the performance degradation.

10. The method of claim 1, wherein the network node is different than another network node associated with the cell that has the NES feature activated.

11. A User Equipment device, UE, configured to store and report information related to Network Energy Savings, NES, associated performance degradation, the UE comprising a radio interface and processing circuitry configured to:
receive a configuration from a network node that configures the UE to store and report information associated with performance degradation associated with NES;
determine that a cell associated with the UE has an NES feature activated;
store the information associated with performance degradation; and
provide a report to the network node that comprises the information associated with performance degradation and information related to the NES feature.

12-20. (canceled)

21. A method performed by a network node for configuring a User Equipment device, UE, to store and report information related to Network Energy Savings, NES, associated performance degradation, the method comprising:
configuring the UE to store and report information associated with performance degradation associated with NES;
receiving a report to the network node that comprises the information associated with performance degradation and information related to the NES feature; and
performing a network operation based on the report.

22. The method of claim 21, wherein the performing the network operation further comprises:
forwarding the report to another network node associated with the cell that has the NES feature activated.

23-26. (canceled)

27. The method of claim 21, further comprising:
receiving a notification from the UE that the information associated with the performance degradation is available; and
providing a request to provide the report to the network node.

28-29. (canceled)

30. A network node configured to configure a User Equipment device, UE, to store and report information related to Network Energy Savings, NES, associated performance degradation, the UE comprising a radio interface and processing circuitry configured to:
configure the UE to store and report information associated with performance degradation associated with NES;
receive a report to the network node that comprises the information associated with performance degradation and information related to the NES feature; and
perform a network operation based on the report.

31-38. (canceled)
